(19) United States
(12) Patent Application Publication
(10) Pub. No.: US 2023/0050355 A1
(43) Pub. Date: Feb. 16, 2023

(54) WUS FOR PAGING FOR RRC INACTIVE STATES

(71) Applicant: Nokia Technologies Oy, Espoo (FI)

(72) Inventors: Daniela LASELVA, Klarup (DK); Jussi-Pekka KOSKINEN, Oulu (FI)

(21) Appl. No.: 17/784,318

(22) PCT Filed: Nov. 3, 2020
(86) PCT No.: PCT/FI2020/050721

§ 371 Date: Jun. 10, 2022

Related U.S. Application Data
(60) Provisional application No. 62/963,651, filed on Jan. 21, 2020.

(51) Int. Cl. H04W 76/27; H04W 68/00; H04W 52/02

(52) U.S. Cl. CPC H04W 76/27; H04W 68/005; H04W 52/0229

(57) ABSTRACT

In accordance with an example embodiment of the present invention, a method comprising determining, by a user equipment in a radio resource control inactive state, whether information has been received from a wireless network, wherein the information is configured to cause the user equipment to access the network; and triggering, by the user equipment and in response to receiving the information, an access to the wireless network, is disclosed.

### CROSS REFERENCE TO RELATED APPLICATION

This application claims the benefit of U.S. Provisional Application No. 62/963,651, filed Jan. 21, 2020. The entire content of the above-referenced application is hereby incorporated by reference.

### TECHNICAL FIELD

This invention relates generally to wireless networks and, more specifically, relates to wake-up signals (WUSs) intended to wake up user equipment from an inactive state.

### BACKGROUND

The third generation partnership project (3GPP) is defining a physical downlink control channel (PDCCH)-based power saving signal/channel to instruct a user equipment (UE) to wake up at the next discontinuous reception (DRX) On-Duration for radio resource control

(RRC) Connected UEs. Recently RANI (RAN working group 1 is responsible for the development of specifications dealing with evolved universal terrestrial radio access, and beyond) denoted such signal as “DCI with CRC scrambled by PS-RNTI”, where DCI is downlink control channel, CRC is cyclic redundancy check, PS stands for power saving, and RNTI is radio network temporary identifier. For simplicity, this is denoted herein as WUS (Wake Up Signaling), as this signaling is indeed used to indicate to the UE to initiate PDCCH monitoring (that is, wake up) for scheduled data at the coming On-Duration. Specifically, the network configures WUS occasions for the UE in dedicated RRC signaling, e.g., with an RRCReconfiguration message.

If a UE does not receive the WUS during the network-defined WUS occasion(s), the UE will assume there is no data and can skip monitoring the PDCCH during the next DRX On-Duration, thus saving power when no data is present. To minimize false alarms (leading to waking up a UE unnecessarily), the WUS signal is targeted to a UE specific identifier, the PS-RNTI. It is noted that the WUS design is still under discussion in the work item on UE power saving in new radio (NR) (see RP-191607, CATT, CAICT, “New WID: UE Power Saving in NR”, 3GPP TSG RAN Meetings #84, Newport Beach, USA, 3-6 Jun. 2019) in conjunction with DRX.

### SUMMARY

In accordance with some embodiments, a method may include determining, by a user equipment in a radio resource control inactive state, whether information has been received from a wireless network, wherein the information is configured to cause the user equipment to access the network. The method may further include triggering, by the user equipment and in response to receiving the information, an access to the wireless network.

In accordance with some embodiments, a method may include sending, by network node and toward a user equipment in a radio resource control inactive state, information that is configured to cause the user equipment to access the network. The method may further include receiving, by the network node and in response to sending the information, an access from the user equipment to the wireless network.

In accordance with some embodiments, an apparatus may include means for performing a process according to any of the methods.

In accordance with some embodiments, a non-transitory computer readable medium may include program instructions stored thereon for performing the method according to any of the methods.

In accordance with some embodiments, an apparatus may include at least one processor; and at least one memory comprising computer program code, the at least one memory and the computer program code are configured, with the at least one processor to cause the apparatus at least to performing a process according to any of the methods.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is an illustration of a new radio (NR) radio resource control (RRC) state machine with RRC state transitions;

FIG. 3 is a signaling diagram illustrating an exemplary embodiment for WUS for paging for RRC Inactive states;

FIG. 4 is a logic flow diagram performed by a UE for WUS for paging for RRC Inactive states, and illustrates the operation of an exemplary method or methods, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this

Detailed Description are exemplary embodiments provided to enable persons skilled in the art to make or use the invention and not to limit the scope of the invention which is defined by the examples.

Abbreviations that may be found in the specification and/or the drawing figures are defined below, at the end of this Detailed Description section.

The exemplary embodiments herein describe techniques for WUS for paging for RRC INACTIVE states. Additional description of these techniques is presented after a system into which the exemplary embodiments may be used is described.

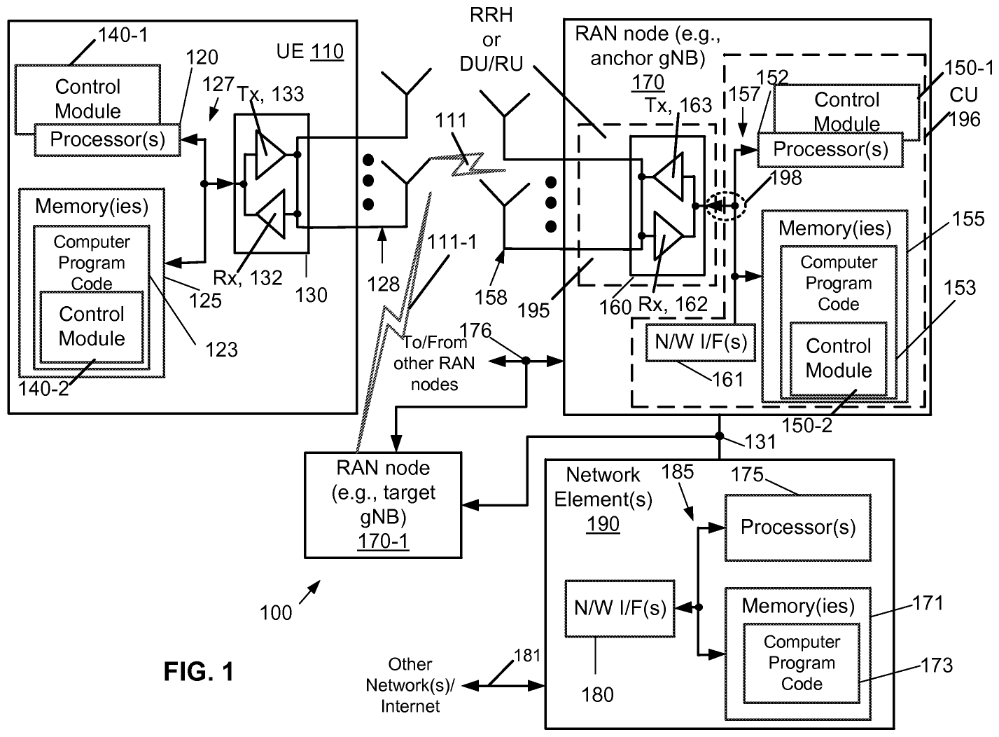

Turning to FIG. 1, this figure shows a block diagram of one possible and non-limiting exemplary system in which the exemplary embodiments may be practiced. A user equipment (UE) 110, two radio access network (RAN) nodes 170 and 170-1, and network element(s) 190 are illustrated. In FIG. 1, a user equipment (UE) 110 is in wireless communication with a wireless network 100.

A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN nodes 170 and 170-1 are base stations that provide access by wireless devices such as the UE 110 to the wireless network 100. Both nodes, as described in more detail below, may be gNBs and therefore may be referred to as such below. The RAN node 170 may be an anchor gNB and the RAN node 170-1 may be a target gNB. The RAN node 170 is considered to be representative of the RAN node 170-1, and therefore the internal circuitry of the RAN node 170 is only described below.

The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

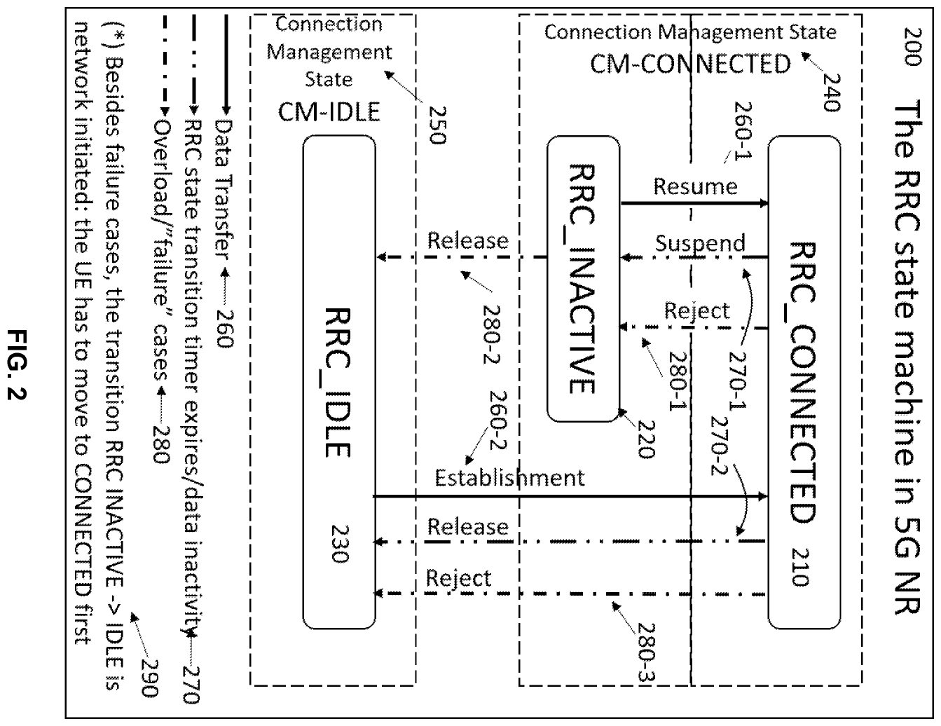

As further introduction, the RRC Inactive state is a new independent RRC state that was introduced in 3GPP NR Rel-15, complementing the existing states, RRC_CONNECTED and RRC_IDLE, with the goal of lean signaling and energy-efficient support of NR services (see 3GPP TSs 38.300/38.304/38.331). The NR RRC state machine comprising the three states is illustrated in FIG. 2. The RRC state machine 200 in 5G NR is illustrated in this figure. Note that the states may be shown in all capital letters, as in the figure (e.g., “RRC_CONNECTED”). The states are the same, however, if capital letters are not used. That is, “RRC_CONNECTED” is the same as RRC Connected or RRC connected. A UE 110 is either in the RRC_CONNECTED state 210 or in the RRC_INACTIVE state 220 when an RRC connection has been established. This is illustrated by reference 240, which states the connection management state is CM-CONNECTED. If this is not the case, i.e., no RRC connection is established, the UE is in RRC_IDLE state 230. This is illustrated by reference 250, which states that the connection management state is CM-IDLE. FIG. 2 also lists the following actions: data transfer actions 260; actions 270, which include RRC state transition timer expires or data inactivity; and actions 280, which are overload/“failure” cases.

As indicated in FIG. 2, the following transitions can be made: from the RRC_CONNECTED state 210 to the RRC_INACTIVE state 220 via a suspend action 270-1 or a reject action 280-1; from the RRC_INACTIVE state 220 to the RRC_CONNECTED state 210 via the resume action 260-1; from the RRC_INACTIVE state 220 to the RRC_IDLE state 230 via the release state 280-2 (where the Release is marked with an asterisk, *, which is explained using reference 290); from the RRC_CONNECTED state 210 to the RRC_IDLE state 230 via the release action 270-2 or the reject action 280-3; and from the RRC_IDLE state 230 to the RRC_CONNECTED state 210 via the establishment action 260-2. Reference 290 indicates the following: (*) Besides failure cases, the transition RRC_INACTIVE to (→) IDLE is network initiated, and the UE has to move to CONNECTED first. Note that while the term “state” is used herein, the term “mode” is also commonly used for these, so that, e.g., the RRC Connected state is the same as the RRC Connected mode.

Although the design of the RRC state machine 200 was conceived particularly for mMTC/MIoT services [see 3GPP TR 22.824, such as 3GPP TR 22.824 V16.0.0 (2018-09)], it could be beneficial to efficiently deliver small and infrequent traffic of eMBB and URLLC services as well. The RRC_INACTIVE state 220 enables quickly resuming the RRC connection and starting the transmission of small or sporadic data with a much lower initial access delay and associated signaling overhead as compared to the RRC_IDLE state 230 (by allowing a faster transition to the RRC_CONNECTED state having about 10 ms CP delay).

This is achieved mainly thanks to reduced control signaling required for requesting and obtaining the resume of a suspended RRC connection, which results in UE power saving. At the same time, a UE in the RRC_INACTIVE state 220 is able to achieve similar power savings as in the RRC_IDLE state 230, benefiting from, e.g., a much larger period between PDCCH monitoring (e.g., paging) and relaxed measurements (e.g., for cell (re)-selection) compared to the RRC_CONNECTED state. In other words, PDCCH monitoring is less frequent. Furthermore, compared to keeping the UE in the RRC_CONNECTED state 210, the new state minimizes mobility signaling both to RAN (e.g., RRC measurement reporting, HO messages) and to the core network (e.g., to/from the AMF) since the UE is still in a CM-CONNECTED state. A UE in the RRC_INACTIVE state 210 can move within an area configured by the RAN node 170 without any notification (i.e., RAN Notification Area (RNA)) and by using a unique identifier, which is the Inactive-RNTI (I-RNTI). More description of RNA can be found from, e.g., 3GPP TS 38.300 (see, e.g., 3GPP TS 38.300 V15.8.0 (2019-12)), clause 9.2.2, “Mobility in RRC_INACTIVE”. This RNA can cover a single or multiple cell(s) and shall be contained within the CN registration area. A RAN-based Notification Area Update (RNAU) procedure is run by the UE periodically and when the UE re-selects to a cell that does not belong to the configured RNA.

As indicated above, to minimize false alarms (leading to waking up a UE unnecessarily), the WUS signal is targeted to a UE specific identifier, the PS-RNTI. WUS in NR is applicable only to UEs in the RRC Connected state 210. The basic WUS applied to RRC Inactive state 220, referred herein as “regular WUS”, i.e., a WUS that triggers a UE in RRC Inactive state 220 to perform PDCCH monitoring for paging, has been briefly discussed in 3GPP, but not agreed upon. Besides that, the topic has not been considered so far. Therefore, potential UE power saving benefits of WUS cannot be currently exploited by RRC Inactive UEs.

Decoding of a regular paging message requires the PDSCH decoding operations, which are more complex compared to decoding of a WUS. Also, regular paging with Paging-RNTI (P-RNTI) wakes up multiple UEs, although the paging may not address all the UEs that received the paging indication. On the other hand, “regular WUS” for the RRC Inactive state 220 would require beam sweeping on all the beams. Furthermore, consecutive paging messages would require beam sweeping or some other beam tracking operations, which all together would cause significant overhead, and therefore these may not be desired.

According to the design being defined as per the Rel-16 UE Power saving in NR WID, the WUS is applicable only to UEs in the RRC Connected state 210. WUS for paging in IDLE/INACTIVE states in NR was discussed in the Rel-16 UE power saving study item but was soon down-prioritized (see 3GPP TR 38.840) because it was assumed to cause network overhead due to beam sweeping. That is, the WUS transmission on every beam would be necessary when sending WUS to IDLE/INACTIVE state UEs because the network does not perform beam tracking for IDLE/INACTIVE state UEs, thus is unaware of the strongest/best beam.

WUS for paging is defined for NB-IoT. Concerning this, what follows is a short description. NB-IoT UEs, BL UEs or UEs in enhanced coverage can use WUS, when configured in the cell, to reduce the power consumption related to paging monitoring. When WUS is used in idle mode, the following are applicable:
1) The WUS is used to indicate that the UE shall monitor MPDCCH or NPDCCH to receive paging in that cell;
2) For a UE not configured with extended DRX, the WUS is associated to one paging occasion (N=1);
3) For a UE configured with extended DRX, the WUS can be associated to one or multiple paging occasion(s) (N [symbol] 1) in a PTW;
4) If UE detects the WUS, the UE shall monitor the following N paging occasions unless the UE has received a paging message;
5) The paging operation in the MME is not aware of the use of the WUS in the eNB.

Thus, if WUS is detected, the UE shall monitor paging.

The exemplary embodiments herein address some or all of these issues and relate to extensions of WUS to the RRC Inactive state 220 and also relate at least to Rel-17 WID follow-up on the UE power saving in NR, whose scope will likely include power saving enhancements for the RRC Inactive state 220. An overview is presented first, and then additional details are presented.

As an exemplary overview, an exemplary notion is introduced that WUS triggers a connection resume for RRC Inactive UEs. In an exemplary embodiment, upon receiving a UE-specific WUS indication, the UE in an RRC Inactive state 220 triggers the resume procedure (rather than triggering PDCCH monitoring for paging during the subsequent paging cycle), and thereby a WUS indication in RRC Inactive can replace completely a paging message. This approach is denoted as “Paging with WUS” and the required signal as “WUS for paging”. Note that during the standardization process, the information waking up the UE and triggering the UE to start an on-duration timer was called a wake-up signal. In a later phase, a terminology change was agreed upon, and this is now information is currently referred to as DCP (which currently refers to DCI with CRC scrambled by PS-RNTI). The WUS used herein, e.g., for paging purposes, also covers the DCP terminology.

In additional exemplary embodiments, the “WUS for paging” signal is used only in the presence of user plane (UP) data to be transmitted in the downlink. Instead “regular WUS”, i.e., WUS that triggers PDCCH monitoring for paging, can be used in the presence of non-user plane data (control plane, CP), such as System Information (SI) update, ETWS, and the like, because in these latter cases the paging message itself contains necessary information and cannot be skipped. “WUS for paging” can coexist with “regular WUS”. The UE can distinguish between the two signals (“WUS for paging” versus “regular WUS”), e.g., by using different UE IDs or by allocating (by the network) different WUS occasions for the two purposes. In the former, the UE in RRC Inactive will monitor WUS targeted to both IDs (i.e. monitoring whether the WUS DCI is scrambled with the UE ID configured either for UP data or CP data). In one example, the network can configure dedicated PS-RNTI identifiers for the UP and non-UP purposes to the UE in the RRC Connected state 210, prior to move to the RRC Inactive state 220. In another example, the PS-RNTI can be set equal to the I-RNTI.

The following are additional embodiments and aspects. These are merely exemplary, and they may be combined or alternative. In one embodiment, UE-specific WUS resources are configured for the UE in dedicated signaling, e.g., using an RRC Release message. In one aspect, UE specific WUS resources are monitored by the UE in the RRC_INACTIVE state 220. In another possible aspect, the WUS triggers an RRC Resume procedure. In a further aspect, a WUS triggers (from the RRC Idle state 230) an RRC Setup Request procedure (e.g., as the establishment action 260-2 in FIG. 2). In an additional aspect, a WUS triggers a random access procedure, which may be performed in both the Resume and Setup request cases. In another further possible aspect, a WUS triggers system information acquisition. In an additional exemplary aspect, certain WUS occasions are configured for triggering an RRC Resume procedure. In an additional possible aspect, certain WUS occasions are configured for triggering system information acquisition. In yet another possible aspect, a UE 110 in the INACTIVE state 220 monitors WUS occasions and is allowed to skip paging monitoring.

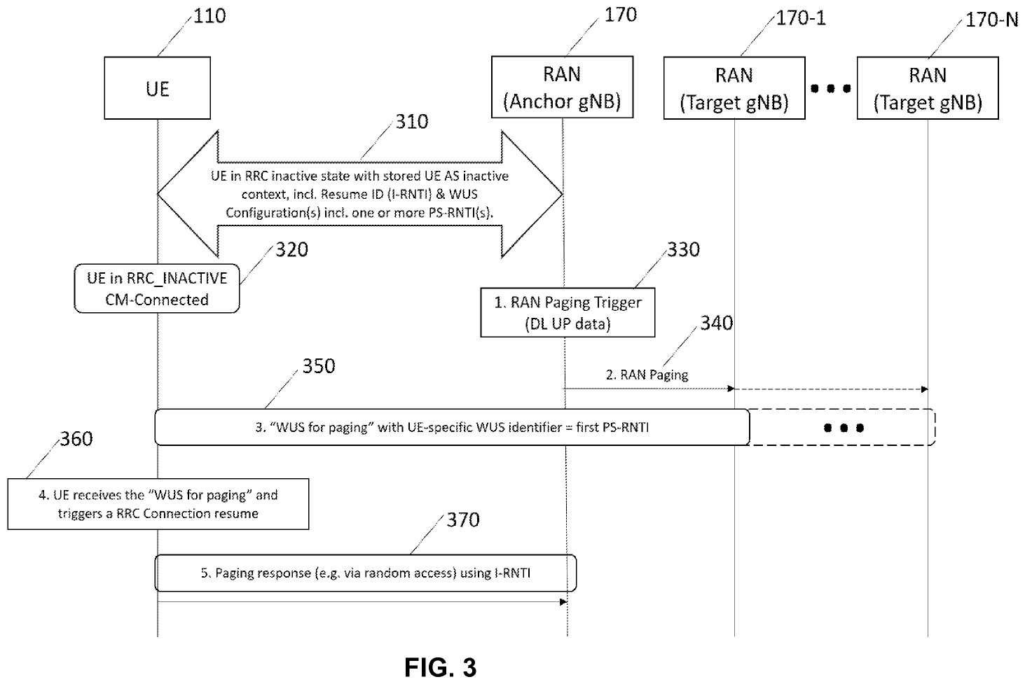

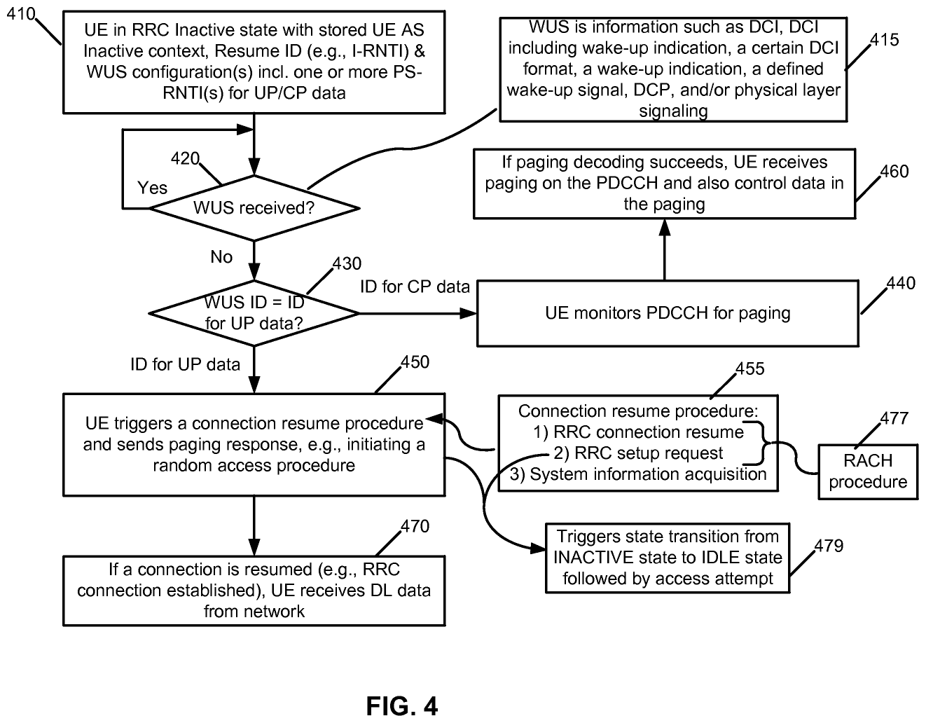

Now that an exemplary overview has been provided, additional details are provided. The signaling flow chart and UE-side flow chart illustrating embodiments of this invention are shown in FIGS. 3 and 4, respectively. FIG. 3 is a signaling diagram illustrating an exemplary embodiment for WUS for Paging for RRC Inactive States. FIG. 4 is a logic flow diagram performed by a UE for WUS for paging for RRC Inactive states. For FIGS. 3 and 4 and any operations performed by the UE 110, these are assumed to be performed under control of the control module 140, and for any operations performed by a RAN node 170, 170-1, these are assumed to be performed under control of the corresponding control module 150.

Turning to FIG. 3, this figure illustrates signaling between the UE 110, the RAN node 170, as an anchor gNB in this example, and RAN node 170-1, as a target gNB in this example. The UE context is stored in the anchor gNB. A target gNB is the gNB where the UE performs the RRC Resume procedure, and there can be many target gNBs. Note that the anchor gNB may itself be a target gNB under this definition. The target gNB 170-1 is within the RNA, and there could be one to multiple ones of these in the RNA. In FIG. 3, there is an optional set of target gNBs to target gNB 170-N. The gNB terms will be used for the examples of FIGS. 3 and 4, although as indicated above, a RAN node may take multiple different forms. The signaling 310 between the UE 110 and the anchor gNB 170 indicates the UE 110 is in an RRC Inactive state 220 with stored UE AS Inactive state context, including (incl.) Resume ID (I-RNTI) and (&) WUS configuration(s) including one or more PS-RNTI(s). Block 320 illustrates that the UE 110 is in the RRC_INACTIVE state 220 of the CM-Connected states 240.

In block 330, the anchor gNB 170 receives (as a first step) a RAN paging trigger, e.g., comprising downlink (DL) user plane (UP) data, and in signaling 340 (a second step) sends RAN paging to the target gNB 170-1. The signaling in reference 350, a third step, indicates a “WUS for paging” signaling is performed with a UE-specific WUS identifier, which is equal (=) to a first PS-RNTI. The signaling for reference 350 is between the UE 110 and either the anchor gNB 170 (as a target node) and one of the one or more target gNBs 170-1 through 170-N. That is, only the target gNB can physically signal with UE via a radio interface (and the anchor gNB is a possible target gNB).

In block 360, a fourth step, the UE receives the “WUS for paging” signaling and triggers a RRC Connection resume 260-1 (see FIG. 2). The signaling in reference 370, a fifth step, indicates the UE 110 sends a paging response (e.g., via a random access procedure) using I-RNTI.

Referring to FIG. 4, this figure is a logic flow diagram performed by a UE for WUS for Paging for RRC Inactive States. This figure also illustrates the operation of an exemplary method or methods, a result of execution of computer program instructions embodied on a computer readable memory, functions performed by logic implemented in hardware, and/or interconnected means for performing functions in accordance with exemplary embodiments.

In block 410, the UE is in the RRC Inactive state 220, with stored UE AS Inactive context, a Resume ID (e.g., I-RNTI), and (&) WUS configuration(s) including (incl.) one or more PS-RNTI(s) for UP/CP data. In block 420, the UE 110 determines whether the WUS was received. If not (block 420=No), the flow proceeds to block 410. If the WUS was received (block 420=Yes), the flow proceeds to block 430.

In block 430, the UE 110 determines whether the WUS ID is equal (=) to the ID for UP data, which was previously stored in block 410. If so (block 430=ID for UP data), in block 450, the UE 110 triggers a connection resume procedure (see 260-1 in FIG. 2), and sends a paging response, e.g., initiating a random access procedure. The term “triggering” is a term of art and is meant to mean that an RRC connection resume procedure is actually performed. The triggering at least sets off the actions that cause the RRC connection resume procedure to be performed. In block 470, if a connection is resumed (e.g., as a result of the random access procedure and via an RRC connection being established), the UE 110 receives DL data from the network.

Although in FIG. 3, the connection resume procedure was the RRC Connection resume procedure, other procedures may be used as illustrated in block 455. This block illustrates the connection resume procedure may be any of the following: 1) RRC connection resume; 2) RRC setup request; or 3) System information acquisition. One possibility for the RRC connection resume and RRC setup request is via a RACH (random access channel) procedure, as illustrated by block 477.

While implementing a RACH procedure is one possibility, other options are possible. For instance, upon receiving the information in blocks 420 and 430, the UE might access the network without performing a RACH procedure, e.g., in case time-alignment is valid. Also, the UE might be pre-configured (e.g., by the gNB 170) with downlink persistent radio resources (e.g., in the form of semi-persistent scheduling, SPS, resources) that the UE is configured to access upon receiving the information in blocks 420 and 430, such as small data reception in an RRC Inactive state over SPS resources triggered by a WUS indication (with or without prior random access).

Additionally, for the RRC setup request, this is from the RRC Idle state 230 (with reference also to FIG. 2) and is one example of an establishment action 260-2. As block 479 illustrates, the triggering that occurs in block 450 can trigger a state transition from the INACTIVE state 220 to the IDLE state 230 followed by an access attempt (e.g., of the RRC setup request as establishment action 260-2).

If the WUS ID is not equal to the ID for UP data (block 430=ID for CP data), in block 440, the UE monitors PDCCH for paging. In block 460, if paging decoding succeeds, the UE 110 receives paging on the PDCCH and also control data in the paging.

In the example of 420 and the description above, it has been assumed that the WUS is a defined WUS. As indicated by block 415, this is only one option, however, and this information can be, e.g., information such as DCI, DCI including a wake-up indication, a certain DCI format, a wake-up indication, a defined wake-up signal, DCP (which currently refers to DCI with CRC scrambled by PS-RNTI), and/or physical layer signaling.

In additional embodiments, the anchor gNB 170 provides to the target cells (e.g., in the target gNBs 170-1), during Xn-based RAN paging within the RNA, the PS-RNTI(s) assigned to an RRC Inactive UE as well as the associated WUS configuration (e.g., WUS occasions, preceding time of the WUS window as compared to a paging cycle).

In further embodiments, the PS-RNTI(s) are discarded by the UE 110 upon moving to the RRC Connected state 210, and instead are retained by the UE when the resume triggered by the “WUS for paging” does not lead to an RRC state change, i.e. the UE is moved back to the RRC Inactive state 220 after the DL data transfer that triggered the paging. The same applies to cases where upon resuming for small data transmission (SDT) in the uplink, the UE 110 is moved back to the RRC Inactive state 200 after the UL data transfer. In other words, the UE keeps the PS-RNTI(s) if the UE preformed an SDT.

Relating to error scenarios, where the network has lost the UE when the UE was in an INACTIVE state (i.e., the UE has moved autonomously from the RRC Inactive state 220 to the RRC Idle state 230, e.g., due to out-of-coverage situations), the UE would not monitor for “WUS for paging” any longer and would instead be paged with the Core Network (CN)/idle mode identifier, i.e. NG-5G-S-TMSI (a Temporary Mobile Subscriber Identity). Until the network detects that the UE moved to the RRC Idle state 230 (e.g., based on missing a periodic RNA update), the use of WUS for paging targeted to Inactive mode related IDs might be missed by the UE and lead to a paging failure similarly as if—in conventional techniques—the network would have sent a paging message addressed to the I-RNTI.

Technical effects and advantages include the following. Paging with WUS is more efficient than regular paging both for the UE and network accounting both UE power saving and network efficiency, for at least the following reasons.

For the UE, paging with WUS requires less UE power consumption compared to decoding regular paging because this type of paging avoids starting the PDSCH decoding operations associated to the regular paging unnecessarily (these should be started in case of regular paging during the PDCCH decoding in case the decoding indicates the presence of a paging message). Also, depending on the network configuration of WUS, the WUS window (during which WUS occasions are placed that are to be monitored by the UE) may be more power friendly (e.g., the WUS window is expected to be shorter and less inter-spaced than the paging occasions to monitor, and possibly with fewer decoding attempts than in regular PDCCH monitoring). Additionally, regular paging with Paging-RNTI (P-RNTI) may result in waking up multiple UEs, so this paging may cause unnecessary power consumption for other UEs too.

For the network, the WUS-specific DCI format defined by 3GPP (i.e., DCI-3_0) will likely have a smaller payload than paging DCI, so PDCCH capacity/coverage can be improved compared to regular paging. Also, although the WUS for paging has to be transmitted on every beam of the paging cell(s), the network can still save paging transmissions on every beam, which would be required too.

As used in this application, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any examples. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular example element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:
3GPP third generation partnership project
5G fifth generation
5GC 5G core network
AMF access and mobility management function
AS access stratum
BL bandwidth limited
BWP bandwidth part
CN core network
CP control plane
CRC cyclic redundancy check
CSI channel-state information
CU central unit
DCI downlink control information
DCP DCI with CRC scrambled by PS-RNTI
DRX discontinuous reception
DU distributed unit
eMBB enhanced mobile broadband
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
ETWS earthquake & tsunami warning system
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
HO handover
ID identification
I/F interface
IRNTI or I-RNTI inactive-RNTI
LTE long term evolution
MAC medium access control
MIoT massive Internet of things
MME mobility management entity
mMTC massive machine type communications
MPDCCH MTC physical downlink channel
MTC machine type communications
NB-IoT narrowband Internet of things
ng or NG next generation
ng-eNB or NG-eNB next generation eNB
NG-5G-S-TMSI 5G S-temporary mobile subscriber identity
NR new radio
N/W or NW network
PCell primary cell
PDCCH physical downlink control channel
PDCP packet data convergence protocol
PDSCH physical downlink shared channel
PHY physical layer
PS-RNTI power saving-RNTI
PTW paging time window
PUCCH physical uplink control channel
PUSCH physical uplink shared channel
RAN radio access network
Rel release
RLC radio link control
RNA RAN notification area
RNAU RAN notification area update
RNTI radio network temporary identifier
RRC radio resource control
RRH remote radio head
RRM Radio resource management
RU radio unit
Rx receiver
SDAP service data adaptation protocol
SDT small data transmission
SGW serving gateway
SI system information
SIB system information block
SMF session management function
SpCell special cell
TS technical specification
Tx transmitter
UE user equipment (e.g., a wireless, typically mobile device)
UP user plane
UPF user plane function
URLLC ultra reliable low latency communications
WID work item description
WUS wake-up signaling

1-26. (canceled)

27. An apparatus, comprising:
at least one processor; and
at least one memory comprising computer program code,
the at least one memory and the computer program code are configured, with the at least one processor to cause the apparatus to:
determine, by the apparatus in a radio resource control inactive state, whether information has been received from a wireless network, wherein the information is configured to cause the apparatus to access the network; and
trigger, by the apparatus and in response to receiving the information, an access to the wireless network.

28. The apparatus of claim 27, wherein the triggered access to the wireless network comprises sending a paging response from the apparatus toward the wireless network.

29. The apparatus of claim 27, wherein the triggered access to the wireless network comprises one of the following:
a radio resource control connection resume procedure;
a radio resource control setup request procedure; or
a system information acquisition procedure.

30. The apparatus of claim 29, wherein the triggered access to the wireless network is one of the radio resource control connection resume procedure or the radio resource control setup request procedure, and the sending the paging response from the apparatus toward the wireless network is performed at least via a random access procedure performed by the apparatus.

31. The apparatus of claim 29, wherein the triggering the access to the wireless network further comprises triggering a state transition from the radio resource control inactive state to a radio resource control idle state followed by an access attempt by the apparatus using the radio resource control setup request procedure.

32. The apparatus of claim 27, wherein the at least one memory and the computer program code are further configured, with the at least one processor to cause the apparatus at least to:
after the determining whether the information has been received, determine whether an identifier received in conjunction with the information corresponds to an identifier for user plane data or an identifier for control plane data; and
in response to the identifier for user plane data being received, perform the triggering of the access to the wireless network.

33. The apparatus of claim 32, wherein the identifier for user plane data comprises a power saving radio network temporary identifier.

34. The apparatus of claim 27, wherein:
determining whether the information has been received from the wireless network comprises determining whether the information is received in a first occasion assigned for the apparatus to perform the access to the wireless network or in a second occasion assigned for the apparatus to perform physical downlink control channel monitoring for paging; and
in response to the information being received in the first occasion assigned for the apparatus to perform the access to the wireless network from the radio resource control inactive state, performing the triggering of the access.

35. The apparatus of claim 27, wherein the information comprises one or more of the following: downlink control information; downlink control information including a wake-up indication; a certain downlink control information format; a wake-up indication; a defined wake-up signal; a downlink control information with a cyclic redundancy check scrambled by a power saving-radio network temporary identifier corresponding to the apparatus; or physical layer signaling.

36. An apparatus, comprising:
at least one processor; and
at least one memory comprising computer program code,
the at least one memory and the computer program code are configured, with the at least one processor to cause the apparatus to:
send, toward a user equipment in a radio resource control inactive state, information that is configured to cause the user equipment to access the network; and
receiving, in response to sending the information, an access from the user equipment to the wireless network.

37. The apparatus of claim 36, wherein the receiving the access from the user equipment to the wireless network comprises receiving a paging response from the user equipment.

38. The apparatus of claim 36, wherein:
sending the information comprises determining whether the information should be sent in a first occasion assigned for the user equipment to perform the access the wireless network or sent in a second occasion assigned for the user equipment to perform physical downlink control channel monitoring for paging; and
in response to the information being sent in the first occasion assigned for the user equipment to perform the access the wireless network from the radio resource control inactive state, performing the receiving of the access.

39. The apparatus of claim 36, wherein the information comprises one or more of the following: downlink control information; downlink control information including a wake-up indication; a certain downlink control information format; a wake-up indication; a defined wake-up signal; a downlink control information with a cyclic redundancy check scrambled by a power saving-radio network temporary identifier corresponding to the user equipment; or physical layer signaling.

40. A method, comprising:
determining, by a user equipment in a radio resource control inactive state, whether information has been received from a wireless network, wherein the information is configured to cause the user equipment to access the network; and
triggering, by the user equipment and in response to receiving the information, an access to the wireless network.

41. The method of claim 40, wherein the triggered access to the wireless network comprises sending a paging response from the user equipment toward the wireless network.

42. The method of claim 40, wherein the triggered access to the wireless network comprises one of the following:
a radio resource control connection resume procedure;
a radio resource control setup request procedure; or
a system information acquisition procedure.

43. The method of claim 42, wherein the triggered access to the wireless network is one of the radio resource control connection resume procedure or the radio resource control setup request procedure, and the sending the paging response from the user equipment toward the wireless network is performed at least via a random access procedure performed by the user equipment.

44. The method of claim 42, wherein the triggering the access to the wireless network further comprises triggering a state transition from the radio resource control inactive state to a radio resource control idle state followed by an access attempt by the user equipment using the radio resource control setup request procedure.

45. The method of claim 40, wherein:
determining whether the information has been received from the wireless network comprises determining whether the information is received in a first occasion assigned for the user equipment to perform the access to the wireless network from the radio resource control idle state or in a second occasion assigned for the user equipment to perform physical downlink control channel monitoring for paging; and
in response to the information being received in the first occasion assigned for the user equipment to perform the access to the wireless network from the radio resource control inactive state, performing the triggering of the access.

46. The method of claim 40, wherein the information comprises one or more of the following: downlink control information; downlink control information including a wake-up indication; a certain downlink control information format; a wake-up indication; a defined wake-up signal; a downlink control information with a cyclic redundancy check scrambled by a power saving-radio network temporary identifier corresponding to the user equipment; or physical layer signaling.
